(19) United States
(12) Patent Application Publication
(10) Pub. No.: US 2009/0296049 A1
(43) Pub. Date: Dec. 3, 2009

(54) PROJECTION DISPLAY DEVICE

(75) Inventors: Hirokazu TERADAIRA, Nagano (JP); Kazuya HARIMOTO, Nagano (JP); Takanori ARUGA, Nagano (JP); Mitsuhiro MIYAUCHI, Nagano (JP)

Correspondence Address: HARNESS, DICKEY & PIERCE, P.L.C., P.O. BOX 828, BLOOMFIELD HILLS, MI, 48303, US

(73) Assignees: Chinontec Industries, Inc., Nagano (JP); Hitachi Maxell, Ltd., Osaka (JP)

(21) Appl. No.: 12/469,730

(22) Filed: May 21, 2009

(30) Foreign Application Priority Data
May 30, 2008 (JP) 2008-142282

(51) Int. Cl. G02B 27/18; G03B 21/20; G03B 21/28

(52) U.S. Cl. 353/98; 353/102

(57) ABSTRACT

A projection display device includes a three-color LED source having a red LED, a green LED and a blue LED, a light pipe for making uniform illumination distribution of light emitted from the three-color LED source, an optical lens for making the light from the light pipe into parallel light, and a light modulation element for modulating the light from the optical lens. The optical lens includes a first toroidal lens element provided with a first entrance face on which the light whose angle with respect to an optical axis is a predetermined angle is incident to image the light, and a first exit face which emits the light incident from the first entrance face, and a second lens element provided with a second entrance face which is adjacently disposed to the first exit face in an optical axis direction.

### CROSS REFERENCE TO RELATED APPLICATION

The present invention claims priority under 35 U.S.C. §119 to Japanese Application No. 2008-142282 filed May 30, 2008, the entire contents of which are incorporated herein by reference.

### FIELD OF THE INVENTION

The present invention relates to a projection display device for enlarging and projecting an image on a screen.

### BACKGROUND OF THE INVENTION

An LED source having an LED (Light Emitting Diode) has been widely used in a projection display device for enlarging and projecting an image on a screen. Further, in the projection display device, a condenser lens has been used for converging light emitted from the LED source to a light modulation element such as a liquid crystal panel. However, in a projection display device using a conventional condenser lens, a loss of light quantity emitted from the LED source is large.

An optical lens is proposed which is capable of reducing a loss of light quantity in US 2008/0037116 A1. In this Patent Reference, an optical lens whose light condensing property is superior is proposed in which a light emitted from the LED source is capable of efficiently condensing to a light modulation element.

The optical lens described in the Patent Reference is superior in light condensing property. On the other hand, needs for downsizing of a projection display device have been recently increased and, in order to cope with the needs for downsizing, a projection display device is also proposed in which a three-color LED source having three color LEDs, i.e., red, green and blue is used as a light source without using a color wheel.

However, the present inventors have examined and found that, when a three-color LED source is used as a light source, the optical lens described in the above-mentioned Patent Reference cannot be assembled with the three-color LED source as it is for use. The problem will be explained below with reference to FIGS. 16(A), 16(B) and 16(C).

As shown in FIG. 16(A), a three-color LED source 201 used as a light source is, for example, provided with a red LED 211, a blue LED 212 and green LEDs 213 which are formed in a square shape. The respective LEDs 211-213 are disposed so that a square is formed by four light emitting faces. As shown in FIG. 16(B), when the optical lens 202 described in the above-mentioned Patent Reference and the three-color LED source 201 are simply assembled with each other as they are for use, the three-color LED source 201 is attached to the optical lens 202 and thus lights emitted from the three-color LED source 201 are irradiated to a light modulation element 203 such as a liquid crystal panel through the optical lens 202.

In this structure, for example, when the red LED 211 disposed at the second quadrant on the three-color LED source 201 emits light and red light is emitted from the three-color LED source 201, as shown in FIG. 16(C), the red light having passed through the optical lens 202 is irradiated to the fourth quadrant of a modulation face 203a of the light modulation element 203. Similarly, for example, when blue light is emitted from the blue LED 212 which is disposed at the third quadrant on the three-color LED source 201, the blue light having passed through the optical lens 202 is irradiated to the first quadrant of the modulation face 203a of the light modulation element 203.

In this manner, in the structure as shown in FIG. 16(B), even when the LEDs 211-213 are switched at a high speed to emit lights and a plurality of lights is successively emitted from the three-color LED source 201, the lights are irradiated only on portions of the light modulation element 203 corresponding to arrangement positions of the LEDs 211-213 and thus apparent color mixture of lights emitted from the three-color LED source 201 is not obtained. In other words, the present inventors have examined and found that simple assembling of the optical lens 202 described in the above-mentioned Patent Reference with the three-color LED source 201 is not applicable.

### SUMMARY OF THE INVENTION

In view of the problem described above, the present invention may advantageously provide a projection display device which is capable of reducing its size by using a three-color LED source and, in addition, which is capable of using an optical lens whose light condensing property is superior as an optical lens for condensing light from the three-color LED source.

According to the present invention, there may be provided a projection display device for enlarging and projecting image on a screen including a three-color LED source having a red LED, a green LED and a blue LED, a light pipe for making uniform illumination distribution of light emitted from the three-color LED source, an optical lens for making the light from the light pipe into parallel light, and a light modulation element which includes a light modulation part for modulating the light from the optical lens. In which the optical lens includes a first toroidal lens element which is provided with a first entrance face which is formed in a ring shape and on which the light whose angle with respect to an optical axis is a predetermined angle is incident to image the light, and a first exit face which is formed in a ring shape and which emits the light incident from the first entrance face, and a second lens element which is provided with a second entrance face which is formed in a ring shape and which is adjacently disposed to the first exit face in an optical axis direction. In accordance with an embodiment of the invention, the angle with respect to the optical axis of the light which is incident on the first entrance face is between 40° (degrees) and 90° (degrees).

In the projection display device in accordance with an embodiment of the invention, the optical lens includes a first toroidal lens element which is provided with a first entrance face which is formed in a ring shape and on which the light whose angle with respect to an optical axis is, for example, between 40° (degrees) and 90° (degrees), is incident to image the light, and a first exit face which is formed in a ring shape and which emits the light incident from the first entrance face, and a second lens element which is provided with a second entrance face which is formed in a ring shape and which is adjacently disposed to the first exit face in an optical axis direction. The optical lens is structured similarly to the optical lens which is described in the above-mentioned Patent Reference, i.e., US 2008/0037116 A1. In other words, the optical lens which is used in the projection display device in accordance with an embodiment of the invention is superior in light condensing property. Further, the projection display device in accordance with an embodiment of the invention is provided with a light pipe for making uniform illumination distribution of light emitted from a three-color LED source and thus, even when the optical lens which is described in the above-mentioned Patent Reference and whose light condensing property is superior is used, the light emitted from the three-color LED source is irradiated on the whole face of the light modulation part in the state that its illumination distribution is uniform. Therefore, when plural colors of lights are successively emitted from the three-color LED source, color mixture of emitted lights is apparently performed. Further, when plural colors of lights are simultaneously emitted from the three-color LED source, color mixture of lights from the three-color LED source is performed. As a result, in the projection display device in accordance with an embodiment of the invention, downsizing of the projection display device is attained by enabling to use the three-color LED source and, at the same time, the optical lens whose light condensing property is superior is used.

As described above, in the projection display device in accordance with an embodiment of the invention, its size is capable of being reduced by using a three-color LED source and, in addition, an optical lens whose light condensing property is superior is capable of being used as an optical lens for condensing light from the three-color LED source.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a schematically explanatory view showing a schematic structure of a projection display device in accordance with an embodiment of the present invention.

FIG. 2 is a view showing an LED source viewed from the “E-E” direction in FIG. 1.

FIGS. 3(A), 3(B) and 3(C) are views for explaining a function of a light pipe shown in FIG. 1.

FIG. 4 is a perspective view showing an optical lens shown in FIG. 1.

FIG. 5 is a sectional view showing an axial cross-section plane containing an optical axis of the optical lens shown in FIG. 4.

FIG. 6 is an explanatory view showing a structure of an imaging channel shown in FIG. 5.

FIG. 7 is a view showing an imaging channel in accordance with another embodiment of the present invention.

FIG. 8 is a view showing an optical lens in accordance with another embodiment of the present invention.

FIG. 9 is a view showing an optical lens in accordance with another embodiment of the present invention.

FIG. 10 is a view showing an optical lens in accordance with another embodiment of the present invention.

FIG. 11(A) is a schematic view showing ray tracing passing through a center imaging channel shown in FIG. 10, and FIG. 11(B) is a schematic view showing ray tracing passing through the outermost imaging channel shown in FIG. 10.

FIG. 12 is a view showing an optical lens in accordance with another embodiment of the present invention.

FIG. 13 is a view showing an optical lens in accordance with another embodiment of the present invention.

FIG. 14 is a schematically explanatory view showing a schematic structure of a projection display device in accordance with another embodiment of the present invention.

FIG. 15 is a schematically explanatory view showing a schematic structure of a projection display device in accordance with another embodiment of the present invention.

FIGS. 16(A), 16(B) and 16(C) are views for explaining a problem in a prior art.

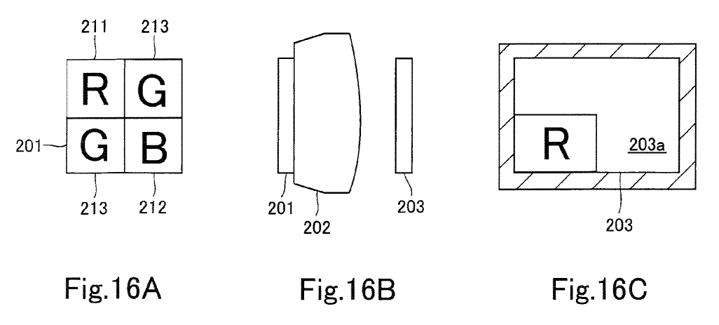

FIG. 17 is an explanatory view showing a principle of an optical lens in accordance with an embodiment of the present invention.

FIG. 18 is an explanatory view showing a principle of an optical lens in accordance with an embodiment of the present invention.

FIG. 19 is an explanatory view showing a principle of an optical lens in accordance with an embodiment of the present invention.

FIG. 20 is an explanatory view showing a principle of an optical lens in accordance with an embodiment of the present invention.

FIG. 21 is an explanatory view showing a principle of an optical lens in accordance with an embodiment of the present invention.

FIG. 22 is an explanatory view showing a principle of an optical lens in accordance with an embodiment of the present invention.

FIG. 23 is an explanatory view showing a distribution pattern of light in an exit pupil of an optical lens in accordance with an embodiment of the present invention.

FIG. 24 is a view showing a light cone in FIG. 23.

FIG. 25 is a view showing an example of an optical lens in accordance with an embodiment of the present invention.

FIG. 26 is a view showing an example of an optical lens in accordance with an embodiment of the present invention.

FIG. 27 is a view showing an example of an optical lens in accordance with an embodiment of the present invention.

FIG. 28 is a cross-sectional view showing an axial cross-section plane of a light source and an optical lens in accordance with an embodiment of the present invention.

FIG. 29 is a view for explaining skew invariance of ray in an optical lens in accordance with an embodiment of the present invention.

FIG. 30 is a view showing Lambertian source together with illumination pupil in accordance with an embodiment of the present invention.

FIG. 31 is a schematic view showing exemplary ray paths in an imaging channel in accordance with an embodiment of the present invention.

### DETAILED DESCRIPTION OF THE PREFERRED EMBODIMENT

An embodiment of the present invention will be described below with reference to the accompanying drawings.

### (Schematic Structure of Projection Display Device)

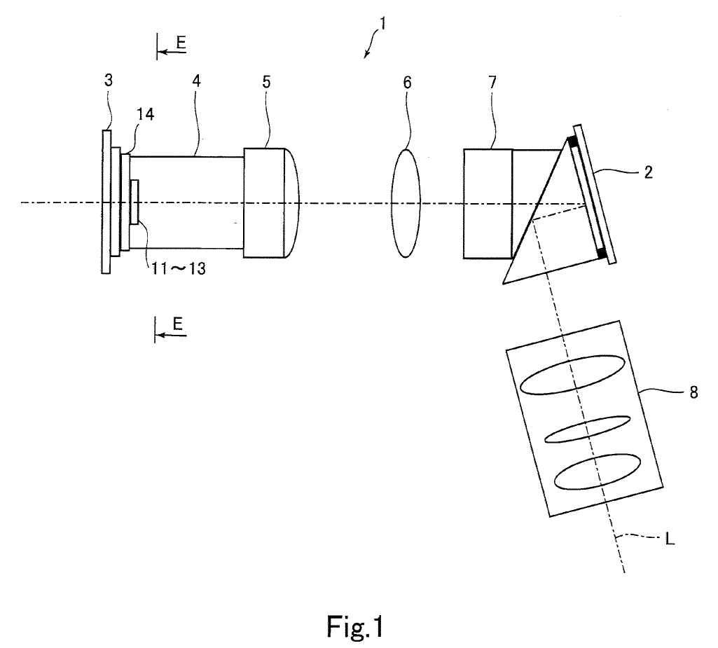

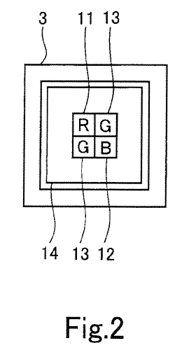

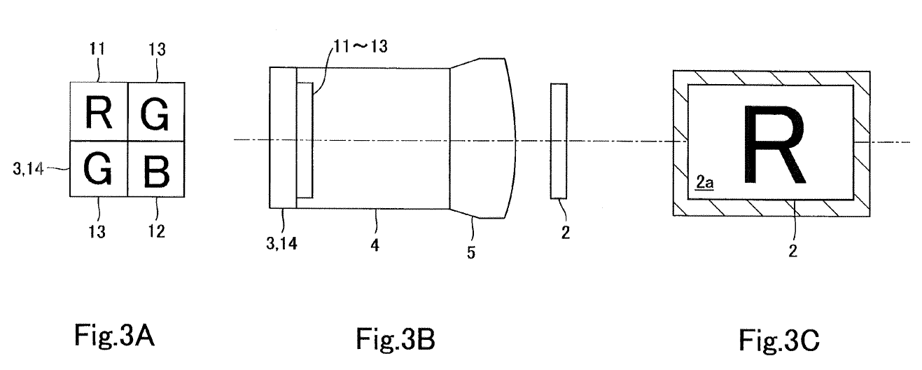

FIG. 1 is a schematically explanatory view showing a schematic structure of a projection display device 1 in accordance with an embodiment of the present invention. FIG. 2 is a view showing an LED source 3 viewed from the “E-E” direction in FIG. 1. FIGS. 3(A), 3(B) and 3(C) are views for explaining a function of a light pipe 4 shown in FIG. 1.

The projection display device 1 in this embodiment is a small display device which utilizes a micro-mirror display element 2 that is a reflection type light modulation element to enlarge and project an image or video on a screen (not shown). As shown in FIG. 1, the projection display device 1 includes, in addition to the micro-mirror display element 2, an LED source 3, a light pipe 4, an optical lens 5, a relay lens 6, an RTIR prism (Reverse Total Internal Reflection (internal total reflection) prism) 7, and a projection lens 8.

In this specification, the “micro-mirror display element” is a light modulation element in which a number of minute mirrors (reflection mirror) having about several μm square is arranged on a silicon substrate. The micro-mirror display element controls whether a light from the light source is reflected toward a screen direction or not by changing inclination of the minute mirror with the use of electrostatic attractive force. The micro-mirror display element is provided with similar functions to an element generally referred to as a DMD which is a brand name of Texas Instruments Inc.

The micro-mirror display element 2 includes a plurality of reflection mirrors (not shown) for modulating and reflecting a light from the LED source 3 and a control circuit (not shown) for controlling the reflection mirrors. In this embodiment, an optical modulation face 2a as a light modulation part for modulating a light from the optical lens 5 is structured with a plurality of the reflection mirrors. As shown in FIG. 3(C), the optical modulation face 2a is formed in a laterally long rectangular shape.

As shown in FIG. 2, the LED source 3 includes, for example, a red LED 11, a blue LED 12 and two green LEDs 13. In other words, the LED source 3 in this embodiment is a three-color LED light source. Each of the LEDs 11-13 is, as shown in FIG. 2, formed so that its light emitting face is in a square shape. Further, the respective LEDs 11-13 are fixed on a common circuit board 14. Specifically, the respective LEDs 11-13 are fixed on the circuit board 14 so that a square-shaped light emitting face is structured by the light emitting faces of four LEDs 11-13.

The light pipe 4 is formed in a square tube shape. The LED source 3 is attached to an end face of the light pipe 4 (left end face in FIG. 1). Specifically, the LED source 3 is attached to one of end faces of the light pipe 4 so that lights from the respective LEDs 11-13 are passed through the inside of the light pipe 4. Alternatively, the LED source 3 is attached to the light pipe 4 so that the respective LEDs 11-13 are disposed in the inside of the light pipe 4. A reflection face is formed on an inside face of the light pipe 4. Further, an emitting port for light which is formed at the other of the end faces of the light pipe 4 (right end face in FIG. 1) is formed in a similar shape to the shape of the optical modulation face 2a. In other words, the emitting port for light of the light pipe 4 is formed in a laterally long rectangular shape.

In accordance with an embodiment of the present invention, the light pipe 4 may be formed in a multi-angular tube shape other than a square or rectangular tube shape, or other shapes such as a cylindrical or elliptical tube shape. Further, the shape of an incidence port for light which is formed in the one of the end faces of the light pipe 4 may be formed in a similar shape to the shape of the light emitting face of the LED source 3 (i.e. square shape) or may be formed in a similar shape to the shape of the optical modulation face 2a (i.e. laterally long rectangular shape). In other words, the shape of the incidence port for light of the light pipe 4 may be different from or similar to the shape of the emitting port for light.

The optical lens 5 is attached to the other end side of the light pipe 4. The optical lens 5 makes light from the light pipe 4 in a parallel light by utilizing refraction and reflection of light. A detailed structure of the optical lens 5 will be described below.

The relay lens 6 is disposed between the optical lens 5 and the RTIR prism 7 in a direction of the optical axis L (optical axis direction). The micro-mirror display element 2 is fixed to the RTIR prism 7. The projection lens 8 has a function to make the reflection mirror of the micro-mirror display element 2 and the screen to be optically conjugate relation and an image formed on the reflection mirror of the micro-mirror display element 2 is enlarged and projected on the screen.

In this embodiment, as described above, the reflection surface is formed on the inside face of the light pipe 4 and the light pipe makes illumination distribution of the light that is emitted from the LED source 3 uniform. In other words, for example, when the red LED 11 is actuated to emit red light from the LED source 3, the red light having passed through the optical lens 5 is irradiated on the whole face of the optical modulation face 2a by the operation of the light pipe 4 as shown in FIG. 3(C). Similarly, when the blue LED 12 or the green LED 13 is actuated to emit blue light or green light from the LED source 3, the blue light or the green light having passed through the optical lens 5 is irradiated on the whole face of the optical modulation face 2a by the operation of the light pipe 4.

Therefore, when the LEDs 11-13 are successively actuated at a high speed to emit plural colors of lights from the LED source 3, color mixture of lights successively emitted from the LED source 3 is apparently performed by the operation of the light pipe 4. Further, when plural colors of lights are simultaneously emitted from the LED source 3, color mixture of lights from the LED source 3 is performed by the operation of the light pipe 4.

In accordance with an embodiment of the present invention, as described above, the emitting port for light of the light pipe 4 is formed in a laterally long rectangular shape. Therefore, lights emitted from the LEDs 11-13 having a square-shaped light emitting face are changed in a laterally long rectangular shape when they have passed through the light pipe 4. In other words, the lights emitted from the LEDs 11-13 having a square-shaped light emitting face are changed in a shape corresponding to an aspect ratio of the optical modulation face 2a of the micro-mirror display element 2 by the operation of the light pipe 4.

In the projection display device 1 structured as described above, light emitted from the LED source 3 becomes illumination light whose illumination distribution is uniform by the light pipe 4 and becomes parallel light by the optical lens 5 and then transmits through the relay lens 6. The illumination light transmitted through the relay lens 6 is transmitted through the RTIR prism 7 to be incident on the micro-mirror display element 2. The illumination light incident on the micro-mirror display element 2 is modulated and reflected so as to be directed toward the projection lens 8 or toward a position separated from the projection lens 8. The imaging light of the reflected light is totally reflected in the inside of the RTIR prism 7 to be enlarged and projected on the screen by the projection lens 8.

### (Structure of Optical Lens)

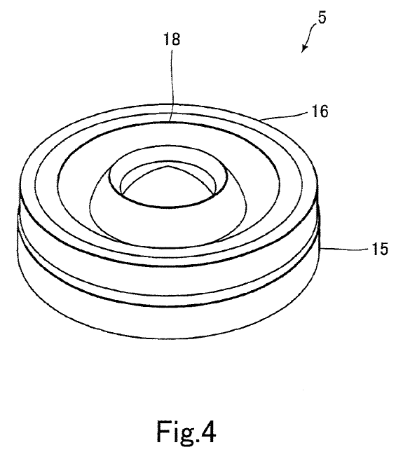

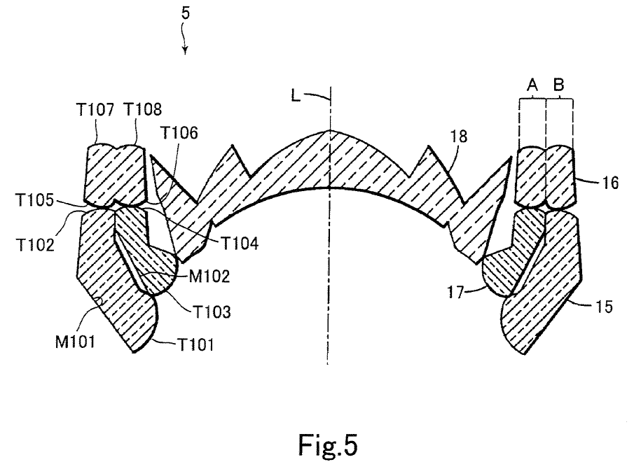

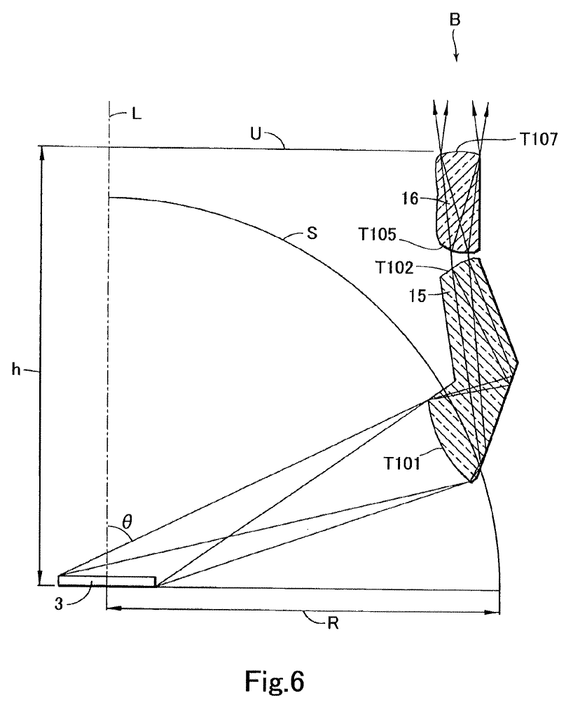

FIG. 4 is a perspective view showing an optical lens 5 shown in FIG. 1. FIG. 5 is a sectional view showing an axial cross-section plane containing an optical axis L of the optical lens 5 shown in FIG. 4. FIG. 6 is an explanatory view showing a structure of an imaging channel B shown in FIG. 5. In this specification, an upper side in FIG. 5 is referred to as “upper” side and a lower side in FIG. 5 is referred to as “lower” side.

A detailed structure of the optical lens 5 will be described below. The optical lens 5 in this embodiment is provided with the same structure and the same function as the “Photon Vacuum” which is a product of Upstream Engineering (Finland). Fundamental conception of the optical lens 5 has been publicly known because it is described in detail in the above-mentioned Patent Reference and thus detailed description of the fundamental conception of the optical lens 5 is omitted in this specification. Further, the structure of the optical lens 5 is described in detail in the above-mentioned Patent Reference, i.e., US 2008/0037116 A1, and thus the optical lens 5 is specified in detail with reference to this Patent Reference.

In FIG. 6, the surface S is a hemisphere face having the radius R with a center of the LED source 3 as its center. The plane U is a plane which is parallel to the light emitting face of the LED source 3 and separated by a distance h from the LED source 3. The distance h is set to be the radius R or more. The plane U is a circular plane having the radius R with the optical axis L as its center.

As shown in FIG. 5, the optical lens 5 is structured of a first lens element 15, a second lens element 16, a third lens element 17 and a fourth lens element 18. The first through fourth lens elements 15-18 are formed of resin such as cyclic olefin copolymer, polymethyl methacrylate (PMMA), polycarbonate (PC) or polystyrene (PS). The first through fourth lens elements 15-18 are formed by injection molding. In accordance with an embodiment of the present invention, the first through fourth lens elements 15-18 may be formed of glass.

The first lens element 15, the second lens element 16 and the third lens element 17 are formed in a substantially toroidal shape with the optical axis L as their center. The third lens element 17 is disposed on an inner peripheral side on an upper side of the first lens element 15. The second lens element 16 is disposed on an upper side of the first lens element 15 and the third lens element 17. The fourth lens element 18 is a Fresnel lens with the optical axis L as its center. The fourth lens element 18 is disposed on inner peripheral sides of the first through the third lens elements 15-17 and surrounded by the first through the third lens elements 15-17.

The first lens element 15 is provided with a ring-shaped entrance (incidence) face T101 on which light emitted from the LED source 3 and passed through the light pipe 4 is incident, a ring-shaped reflection face M101 which totally reflects the incident light, and a ring-shaped exit (emission) face T102 which emits the light reflected by the reflection face M101.

As shown in FIG. 5, an inner peripheral face on a lower end side of the first lens element 15 is formed as the entrance face T101. The entrance face T101 is formed in a curved surface, which is a refraction plane where incident light is refracted. Further, an inner face of the outer peripheral face on the lower side of the first lens element 15 is the reflection face M101. The reflection face M101 is formed in a straight shape in an axial cross-section plane including the optical axis L. An upper end face of the first lens element 15 is the exit face T102. The exit face T102 is formed in a curved surface, which is a refraction plane where an emitted light is refracted.

The third lens element 17 is, similarly to the first lens element 15, provided with a ring-shaped entrance (incidence) face T103 on which light emitted from the LED source 3 and passed through the light pipe 4 is incident, a ring-shaped reflection face M102 which totally reflects the incident light, and a ring-shaped exit (emission) face T104 where the light reflected by the reflection face M102 is emitted.

As shown in FIG. 5, an inner peripheral face on the lower end side of the third lens element 17 is the entrance face T103. The entrance face T103 is formed in a curved surface, which is a refraction plane where light is refracted. An inner face of an outer peripheral face on the lower side of the third lens element 17 is the reflection face M102. The reflection face M102 is formed in a straight line shape in an axial cross-section plane including the optical axis L. An upper end surface of the third lens element 17 is the exit face T104. The exit face T104 is formed in a curved surface, which is a refraction plane where the emitted light is refracted.

The second lens element 16 is provided with ring-shaped entrance (incidence) faces T105 and T106 on which lights from the exit faces T102 and T104 are incident, and ring-shaped exit (emission) faces T107 and T108 where the lights passed through the second lens element 16 are emitted. The entrance faces T105 and T106 are adjacently disposed to the exit faces T102 and T104 in the optical axis direction. The entrance faces T105 and T106 are formed in a curved surface, which is a refraction plane where the incident light is refracted. The exit faces T107 and T108 are formed in a curved surface, which is a refraction plane where the emitted light is refracted. In this embodiment, the second lens element 16 is provided with no reflection face for reflecting the incident light. Further, gap is formed between the exit faces T102 and T104 and the entrance faces T105 and T106, and appropriate material may be filled into the gap.

As can be seen from the ray tracings shown in FIG. 6, the first lens element 15 and an outer portion in the radial direction of the second lens element 16 are arranged in optical series with each other, which structure an imaging channel B. The entrance face T101 forms an entrance pupil for light entered from the LED source 3 and the exit face T107 forms an exit pupil for light entering the entrance pupil T101. Similarly, an inner portion in the radial direction of the second lens element 16 and the third lens element are arranged in optical series with each other, which structure an imaging channel A. The entrance face T103 forms an entrance pupil for light entered from the LED source 3 and the exit face T108 forms an exit pupil for light entering the entrance pupil T103.

As described above, the optical lens 5 in this embodiment is structured of the fourth lens element 18 (Fresnel lens) disposed with the optical axis L as its center and two imaging channels A and B.

The entrance face T101 of the first lens element 15 and the entrance face T103 of the third lens element 17 are incident with light, for example, whose angle θ with respect to the optical axis L is about 40° (degrees) or more of the light emitted from the LED source 3. Further, the fourth lens element 18 is incident with light whose angle θ with respect to the optical axis L is about less 40° (degrees) of the light emitted from the LED source 3. In this embodiment, since the third lens element 17 is disposed on the inner peripheral side of the first lens element 15, the angle θ of the light incident on the entrance face T103 is smaller than the angle θ of the light incident on the entrance face T101.

The entrance faces T101 and T105 and the exit faces T102 and T107 are torus-like surface and do not have imaging power in a tangential direction which is perpendicular to the axial cross-section plane including the optical axis L but have imaging power in the axial cross-section plane. In any cross-sectional plane including the optical axis L, the entrance face T101 images light from the LED source 3 through the reflection face M101 into an intermediate image approximately between the exit face T102 and the entrance face T105. The exit face T102 and the entrance face T105 make an image on the entrance face T101 image on the exit face T107. Further, the exit face T107 images the intermediate image to infinity and forms a rectangular telecentric illumination pattern. In other words, in any cross-sectional plane including the optical axis L, the desired transformation is formed.

Similarly, the entrance faces T103 and T106 and the exit faces T104 and T108 are torus-like surface and do not have imaging power in a tangential direction which is perpendicular to the axial cross-section plane including the optical axis L but have imaging power in the axial cross-section plane. In any cross-sectional plane including the optical axis L, the entrance face T103 images light from the LED source 3 through the reflection face M102 into an intermediate image approximately between the exit face T104 and the entrance face T106. The exit face T104 and the entrance face T106 make an image on the entrance face T103 image on the exit face T108. Further, the exit face T108 images the intermediate image to infinity and forms a rectangular telecentric illumination pattern. In other words, in any cross-sectional plane including the optical axis L, the desired transformation is formed.

In this embodiment of the present invention, since geometry of the imaging channels A and B is optimized by using aspherical cross-section surfaces of the entrance faces T101, T103, T105 and T106 and the exit faces T102, T104, T107 and T108, the desired transformation is performed accurately.

In the tangential direction, the angular magnification is defined by the distance of the entrance face T101 (or T103) from the optical axis L and the distance of the exit face T107 (or T108) from the optical axis L. This is because of the cylindrical symmetry of the first through the third lens elements 15-17, from which it follows that the skewness of each ray is invariant. Skewness is the product of the distance of the ray from the optical axis L and the tangential component of the ray. In this embodiment, since the entrance face T101 and the exit face T107 are spaced the same distance (on average) from the optical axis L, the tangential component at the exit face T107 is the same as the tangential component at the entrance face T101. Similarly, in this embodiment, since the entrance face T103 and the exit face T108 are spaced the same distance (on average) from the optical axis L, the tangential component at the exit face T108 is the same as the tangential component at the entrance face T103. In other words, since channel entrance and exit pupils are spaced the same distance (on average) from the optical axis, the tangential component at the exit pupil is therefore the same as at the entrance pupil, which means that the desired transformation is formed.

In accordance with an embodiment of the present invention, the reflection faces M101 and M102 may be provided between the entrance faces T105, T106 and the exit faces T107, T108 instead of providing between the entrance faces T101, T103 and the exit faces T102, T104. Further, the reflection faces M101 and M102 may be provided between the exit faces T102, T104 and the entrance faces T105, T106.

Further, in the embodiment described above, the second lens element 16 is one piece of lens element on which lights from the first lens element 15 and the third lens element 17 are incident. However, instead of the second lens element 16, two separate lens elements, i.e., one lens element on which light from the first lens element 15 is incident and another lens element on which light from the third lens element 17 is incident, may be provided. Further, the first through fourth lens elements 15-18 may be structured in an integral manner.

### Main Effects of this Embodiment

As described above, in this embodiment, the optical lens 5 includes the first lens element 15 which is provided with the entrance face T101 on which light, for example, whose angle θ with respect to the optical axis L is about 40° (degrees) or more is incident to form image of light and the exit face T102 for emitting the light incident from the entrance face T101, and the second lens element 16 which is provided with the entrance face T105 adjacent to the exit face T102 in the optical axis direction. The optical lens 5 is structured similarly to the optical lens which is disclosed in the above-mentioned Patent Reference. In other words, the light condensing property of the optical lens 5 in this embodiment is superior. Further, since the projection display device 1 includes the light pipe 4, even when the optical lens 5 whose light condensing property is superior is used, the light emitted from the LED source 3 is irradiated on the whole face of the optical modulation face 2a in the state that its illumination distribution is uniform. Therefore, as described above, when plural colors of lights are successively emitted from the LED source 3, color mixture of emitted lights is apparently performed by the operation of the light pipe 4. Further, when plural colors of lights are simultaneously emitted from the LED source 3, color mixture of lights from the LED source 3 is performed. As a result, in this embodiment, downsizing of the projection display device 1 is attained by using the LED source 3 that is a three-color LED source and, at the same time, the optical lens 5 whose light condensing property is superior is used.

In this embodiment, the first lens element 15 is provided with the reflection face M101 which reflects the light incident on the entrance face T101 toward the exit face T102. Further, in this embodiment, the optical lens 5 is provided with the third lens element 17 having the entrance face T103 and the exit face T104, and the second lens element 16 is provided with the entrance face T106 which is adjacent to the exit face T104 in the optical axis direction. Further, the third lens element 17 is disposed on the inner side in the radial direction of the first lens element 15. Therefore, light condensing property of the optical lens 5 is effectively enhanced.

In this embodiment, the red LED 11, the blue LED 12 and the green LED 13 are mounted on the common circuit board 14. Therefore, the number of the circuit board 14 which is used for the LED source 3 is reduced to make the size of the LED source 3 smaller.

In this embodiment, the shape of the emitting port for light of the light pipe 4 is similar to the shape of the optical modulation face 2a. Therefore, the light emitted from the LED source 3 is efficiently converged on the micro-mirror display element 2. Further, in this embodiment, since the LED source 3 is disposed in the inside of the light pipe 4, leakage of light emitted from the LED source 3 is prevented to efficiently converge the light emitted from the LED source 3 on the micro-mirror display element 2.

### (Modified Examples of Imaging Channel)

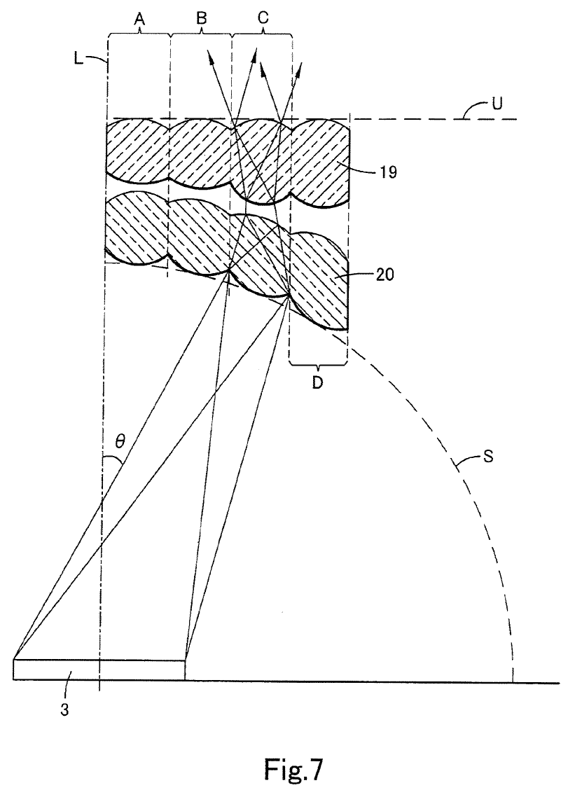

In the embodiment described above, light whose angle θ with respect to the optical axis L is relatively larger is incident on the imaging channels A and B. However, the present invention is not limited to this embodiment. For example, it may be structured so that light near the optical axis L whose angle θ with respect to the optical axis L is smaller is incident on the imaging channel. When the distance h between the LED source 3 and the plane U is substantially larger than the radius R of the hemisphere S, it might be difficult to use the Fresnel lens at the center (near the optical axis L). This is because the opening angle requirement does not match with the lens surface position requirement. In this case, it is possible to use imaging channels A, B, C and D having no mirror-surface (reflection face) as shown in FIG. 7.

Lens elements 19 and 20 shown in FIG. 7 are formed in a roughly disk-like shape with the optical axis L as their center. The two lens elements 19 and 20 structure four imaging channels A, B, C and D having no reflection face. The lens elements 19 and 20 are incident with lights whose angle θ with respect to the optical axis L is relatively smaller and thus a reflection face is not required. In this manner, the lens elements 19 and 20 structuring the imaging channels A through D may be used instead of using the fourth lens element 18 in the embodiment described above.

In the embodiment described above, the entrance face T105 and the exit face T107 are formed on the second lens element 16 for providing a predetermined function. However, the present invention is not limited to this embodiment. For example, the exit face T102 may be provided with a function of the entrance face T105 by setting the radius of curvature of the exit face T102 of the first lens element 15 to be smaller. In this case, for example, a toroidal lens having a function equivalent to the function of the exit face T107 is disposed on the upper side of the first lens element 15.

Further, instead of using the first lens element 15 and the second lens element 16, a toroidal lens having a function equivalent to the function of the entrance face T101, a toroidal lens having a function equivalent to the function of the exit face T107, a toroidal lens having a function equivalent to the function of the exit face T102 and the entrance face T105, and a reflection member having a function equivalent to the function of the reflection face M101 may be disposed.

In the embodiment described above, the entrance faces T101, T105 and the exit faces T102, T107 are formed in a curved surface but they may be formed in a planar shape. In this case, a minute optical element such as diffraction grating may be formed on the surface of the entrance faces T101, T105 and the exit faces T102, T107.

### (Modified Examples of Optical Lens)

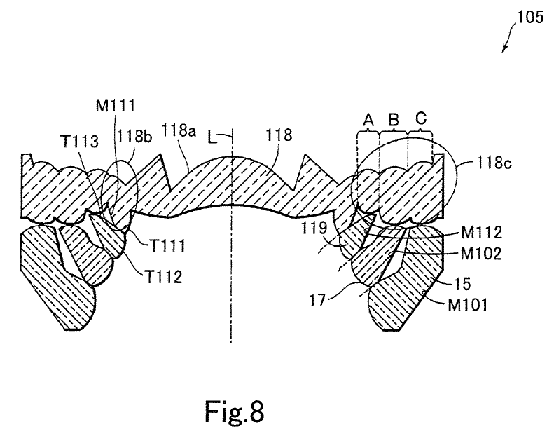

In the embodiment described above, the optical lens 5 is structured of the fourth lens element 18 (Fresnel lens) disposed with the optical axis L as its center and the two imaging channels A and B. However, the present invention is not limited to this embodiment. For example, as shown in FIG. 8, an optical lens 105 may be structured of a Fresnel lens which is disposed with the optical axis L as its center, a refraction reflection structure disposed on an outer side of the Fresnel lens, and three imaging channels A, B and C disposed on an outer side of the refraction reflection structure. In the example shown in FIG. 8, a Fresnel lens portion 118a, a refraction reflection structuring portion 118b having an entrance face T111 and a reflection face M111 which are formed in a curved shape, and an upper side portion 118c of the imaging channels A through C are integrated with each other to structure the fourth lens element 118. Further, a lower side portion of the imaging channel A disposed on the center side of the optical lens 105 is provided with a distinct fifth lens element 119. The fifth lens element 119 is provided with an entrance face T112 and an exit face T113 which are formed in a curved face and a reflection face M112. In the example shown in FIG. 8, an upper side portion 118c of the imaging channels A through C functions as the second lens element 16 in the embodiment described above.

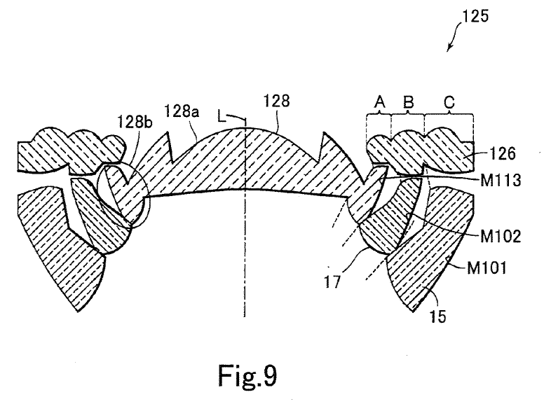

Further, as shown in FIG. 9, an optical lens 125 may be structured of a fourth lens element 128 having a Fresnel lens part 128a disposed with the optical axis L as its center and a refraction reflection structuring portion 128b disposed on an outer side of the Fresnel lens part 128a, and a second lens element 126 which structures an upper side portion of three imaging channels A, B and C disposed on an outer side of the Fresnel lens part 128a. In the optical lens 125, a lower portion of the imaging channel A disposed on the center side is a refraction reflection structuring portion 128b, which is provided with a reflection face M113. In the example shown in FIG. 9, the reflection faces M101, M102 and M113 are formed in a curved face and serve as a part for imaging entrance pupils of respective imaging channels A, B and C to intermediate images, which are located between the first lens element 15, the third lens element 17 and the refraction reflection structuring portion 128b and the second lens element 126.

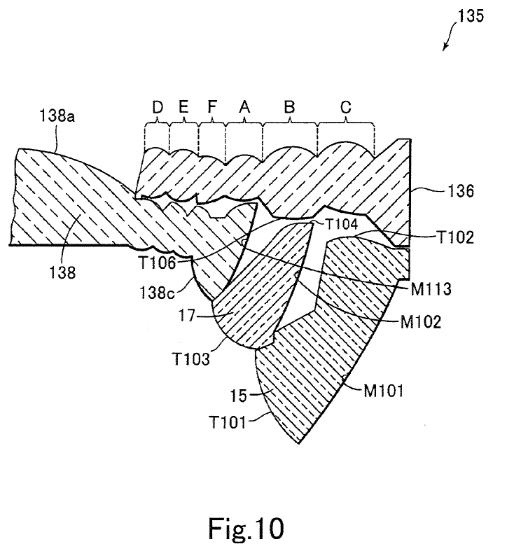

Further, as shown in FIG. 10, an optical lens 135 may be provided with three imaging channels D, E, and F which are disposed on the center side and have no reflection face, and three imaging channels A, B and C which are provided with a reflection face M101, M102 or M113 and disposed on an outer side. In the optical lens 135, all lights incident on the entrance face T103 of the third lens element 17 pass through the third lens element 17 and their directions are changed toward the entrance face T106 of the second lens element 136 through the exit face T104 of the third lens element 17. The fourth lens element 138 is structured of a convex lens portion 138a and lower side portions 138c of the imaging channels D through E, which are integrated with each other.

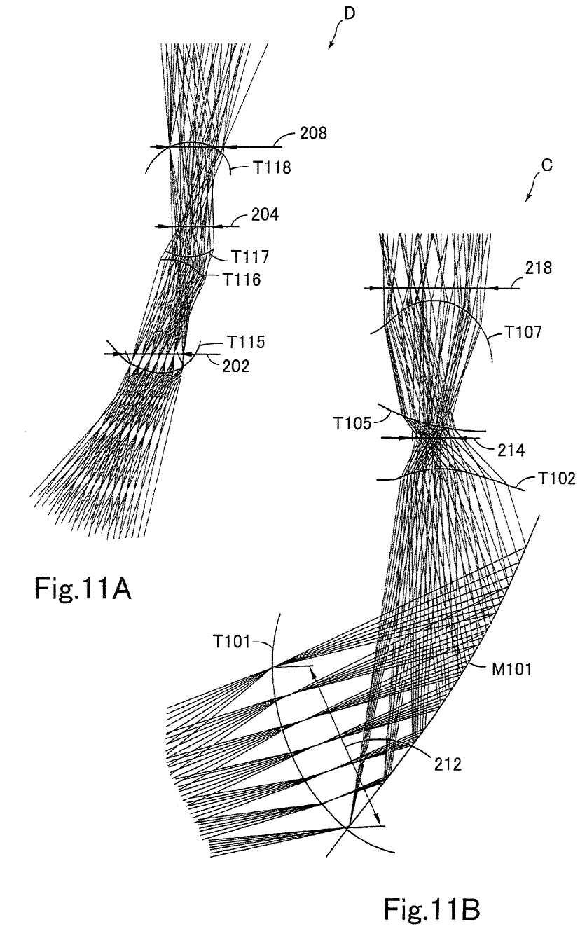

FIG. 11(A) is a schematic view showing ray tracing passing through a center imaging channel D shown in FIG. 10. The imaging channel D of the optical lens 135 is, as shown in FIG. 11(A), provided with two entrance faces T115, T117 and two exit faces T116, T118. The entrance faces T115, T117 and the exit faces T116, T118 substantially form an mirror image of the LED source 3 to infinity in the optical axis direction and which substantially form a non-mirror image of the LED source 3 into infinity in the tangential direction. The entrance face T115 substantially images the LED source 3 into an intermediate image 204, which is then substantially imaged by the exit face T118 to the infinity. The entrance face T117 and the exit face T116 substantially image an entrance pupil 202 of the imaging channel D into an exit pupil 208 of the imaging channel D. The entrance faces T115, T117 and the exit faces T116, T118 are formed in an aspherical face.

FIG. 11(B) is a schematic view showing ray tracing passing through the outermost imaging channel C shown in FIG. 10. The imaging channel C of the optical lens 135 is, as shown in FIG. 11(B), provided with two entrance faces T101, T105 and two exit faces T102, T107. The entrance faces T101, T105 and the exit faces T102, T107 substantially form an mirror image of the LED source 3 to infinity in the optical axis direction. The entrance face T101 and the reflection face M101 substantially image the LED source 3 into an intermediate image 214, which is then substantially imaged by the exit face T107 to the infinity. The exit face T102 and the entrance face T105 substantially image an entrance pupil 212 of the imaging channel C into an exit pupil 218 of the imaging channel C. The reflection face M101 reflects the light by total internal reflection. The entrance faces T101, T105, the exit faces T102, T107 and the reflection face M101 are formed in an aspherical face.

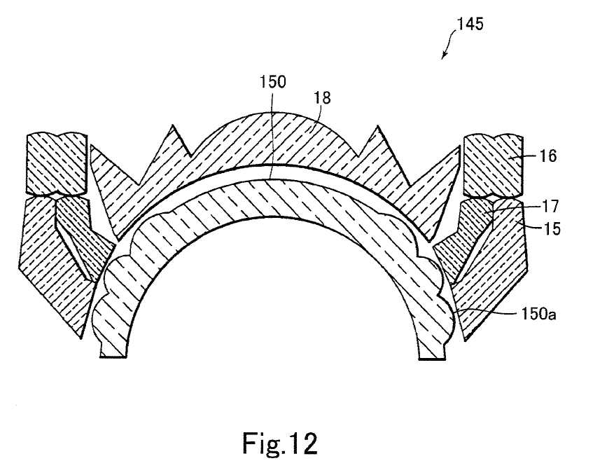

Further, as shown in FIG. 12, an optical lens 145 may be provided with a sixth lens element 150 which is formed in a hemispheric shape. In this case, functions of the entrance faces T101 and T103 may be partially or fully incorporated on an outer surface 150a of the sixth lens element 150. In the example shown in FIG. 12, a surface of the first lens element 15 and a surface of the third lens element 17, which face the sixth lens element 150, are formed more planer than the surface of the first lens element 15 and the surface of the third lens element 17 shown in FIG. 5.

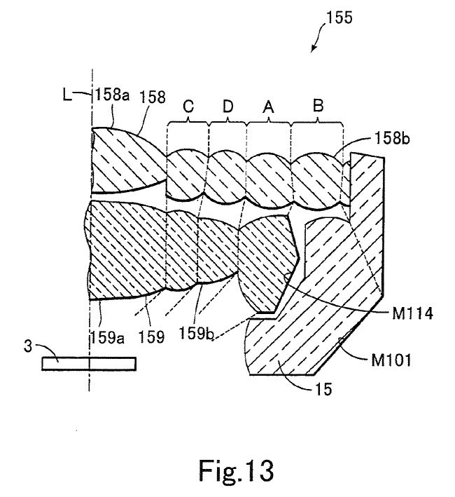

Further, as shown in FIG. 13, an optical lens 155 may include two imaging channels C and D which are disposed on the center side and have no reflection face, and two imaging channels A and B which are provided with a reflection face M101 or M114 and disposed on an outer side. In this case, a lens element 158 is structured of a convex lens portion 158a with the optical axis L as its center and an upper side portion 158b of the imaging channel A through D, and a lens element 159 is structured of a convex lens portion 159a with the optical axis L as its center and a lower side portion 159b of the imaging channels A, C and D. Further, the optical lens 155 is structured of three lens elements, i.e., the first lens element 15 and the lens elements 158 and 159. In the example shown in FIG. 13, an upper side portion 158b of the imaging channels A through D functions as the second lens element 16 in the embodiment described above. Further, a part of the lower side portion 159b of the imaging channels A, C and D functions as the third lens element 17 in the embodiment described above.

Although some modified examples of the optical lens have been shown and described above but the number of the channels may be varied arbitrarily. When the number of the imaging channels is set properly and the entrance face, the exit face and the reflection face are formed in an aspherical surface, substantially accurate imaging function can be attained.

### (Modified Examples of Projection Display Device)

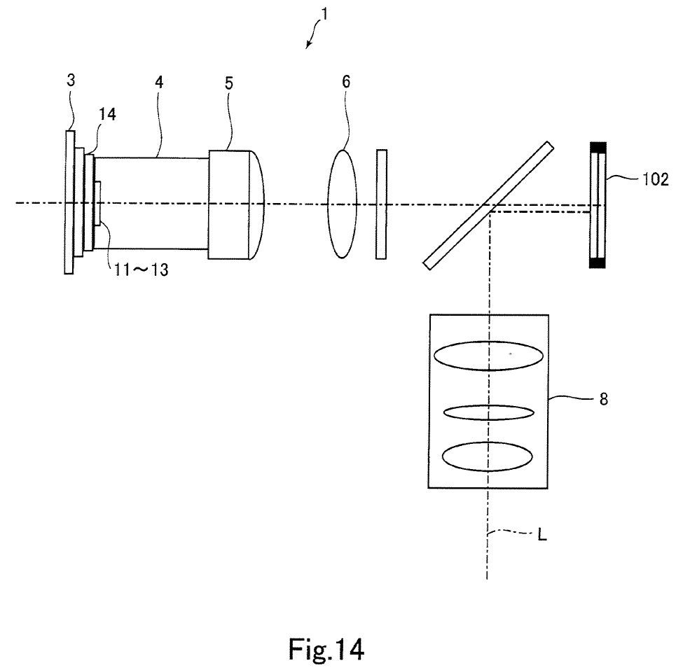

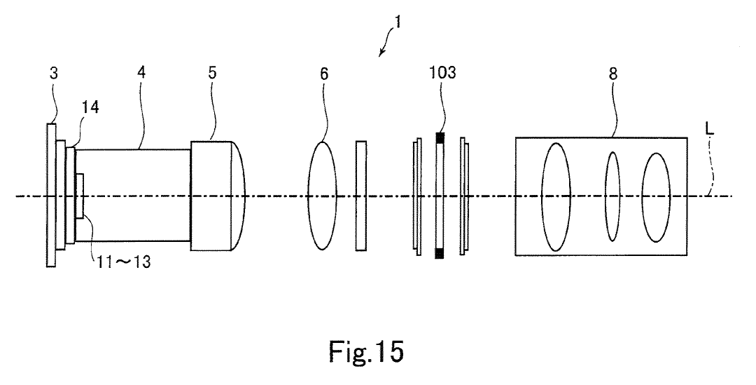

In the embodiment described above, the projection display device 1 enlarges and projects an image on a screen with the use of the micro-mirror display element 2. However, the present invention is not limited to this embodiment. For example, as shown in FIG. 14, the projection display device 1 may enlarge and project an image on a screen with the use of a reflection type liquid crystal panel (LCOS) 102 as a light modulation element. Further, as shown in FIG. 15, the projection display device 1 may enlarge and project an image on a screen with the use of a transmission type liquid crystal panel (LCD) 103 as a light modulation element. In these cases, the projection display device 1 includes a polarizing plate, a retardation plate and the like for arranging a deflection direction of light which is incident on the reflection type liquid crystal panel 102 or the transmission type liquid crystal panel 103.

### Other Embodiments

In the embodiment described above, the LED source 3 is attached to one of end faces of the light pipe 4 formed in a cylindrical shape and one piece of the incidence port for light to the light pipe 4 is provided. However, the present invention is not limited to this embodiment. For example, the light pipe may be formed in a roughly Y shape so as to have two incidence ports for light. In this case, a circuit board on which LEDs are mounted is disposed to respective incidence ports. Further, in the embodiment described above, the LED source 3 is provided with four LEDs 11-13 but the LED source 3 may be provided with, for example, six LEDs 11-13.

### (Regarding Optical Lens)

An optical lens in accordance with an embodiment of the present invention will be further described below. The following description is based on the above-mentioned Patent Reference, i.e., US 2008/0037116 A1.

The optical lens in accordance with an embodiment of the invention offer one or more of the following advantages.
(1) The optical lens has a good condensing efficiency, i.e. illumination efficiency can be even more than 80% (spectral transmission efficiency).
(2) The illumination is so uniform and rectangular that a separate beam homogenizer component such as a fly's eye lens is not needed (though one may be used).
(3) The optical lens has the advantage that it enables collection of light from a whole hemisphere about the light source even if the source is encapsulated by a higher refractive index material.
(4) The optical lens also performs beam shaping by using the shape of the source in beneficial way, i.e. the shape of the illumination is the shape of the source.
(5) Etendue of the illumination can be preserved below 140% of the original etendue of the source, and even below 105% of the original etendue of the source.
(6) The size of the optical lens is very compact.
(7) The optical lens has a circular outer shape, which enables good pupil matching with a projection lens in a miniature projection display device. This enables a small overall size for the projection display device.
(8) The output beam of the optical lens can be very telecentric, which allows to increase efficiency of illumination in the projection display device.
(9) The uniform telecentric beam that the optical lens forms may be used in a wide variety of optical configurations and applications.
(10) The components of the optical lens can be mass-manufactured by injection molding. The molds can be made by diamond turning or precision NC machining, for instance.
(11) In addition to miniature projection display devices, the optical lens can be used in a wide variety of different applications including camera flashes, microscopes and head-up displays, for instance.

Consider an imager for which a planar object is to be imaged to a coplanar image at a distance L1 from the object. The optical axis connects the center points of the object and the image, and the optical axis is perpendicular to the object plane and to the image plane. Magnification M of the imaging is the ratio of the heights of the image and the object. Near the optical axis, the imager includes one or more lenses which image the object to the image. Such lenses operate on light incident at relatively small angles to the optical axis. Lenses can be designed by using conventional lens design principles. For example, an aspherical lens with focal length of (f=ML1/(M+1)²) positioned at distance R=L1/(M+1) from the object can be used. This is conventional.

The imaging channels in accordance with an embodiment of the present invention collect and manipulate light at larger angles from the optical axis. These may be supplemental to conventional lenses that operate at the smaller angles, so according to an embodiment, an optical lens includes one or more of the imaging channels.

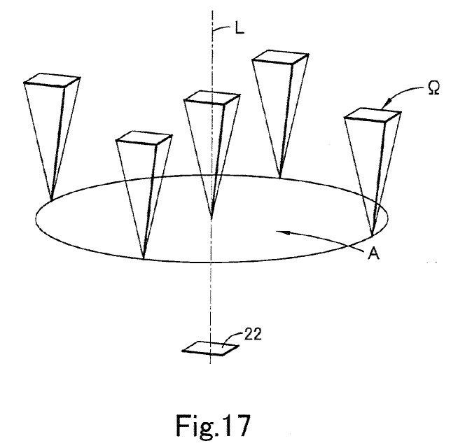

In order to image lights with relatively larger angles from the optical axis, as shown in FIG. 17, a LED radiation pattern needs to be modified so as to get a circular area radiating with a uniform light. An important design consideration is that the etendue of the illumination i.e. Ω A should be as close as possible to the original etendue of the LED chip.

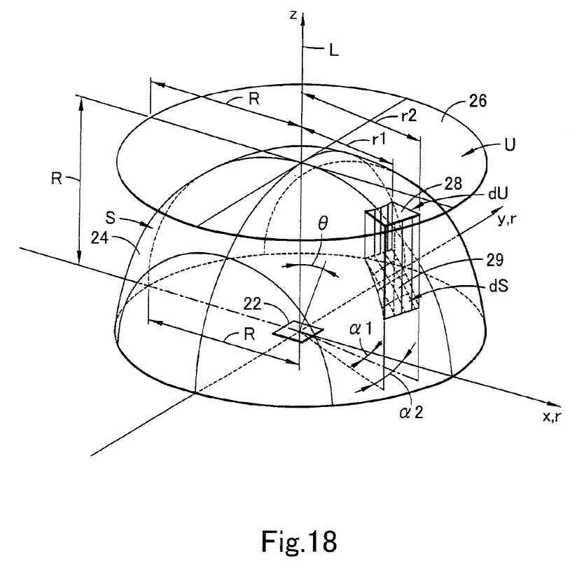

The optical lens in accordance with an embodiment of the invention is based on the findings described below. FIG. 18 illustrates some dimensions and parameters used in formulating the mathematical solution. Let the z-axis be the optical axis L. Circular coordinates in the xy-plane (perpendicular to the z axis) are defined by radius r and angle α. The angle to the optical axis L is denoted by θ. Assume a rectangular Lambertian source 22 (e.g., LED chip) and place it on the xy-plane so that its center point is located at the origin. Let us suppose that under the Lambertian source 22, there is a mirrored surface so that only light going towards the upper hemisphere above the Lambertian source 22 needs to be collected. Now form a hemisphere with surface S (24) having radius R centered at the origin. There is a circular area U (26) parallel to the xy-plane with radius R, and centered on the z-axis at a distance at least R from origin. (In FIG. 18 the distance is R but it could be larger as well). Now, consider a small arbitrary area element dU (28) inside the circular area U, defined by circular coordinates α1, α2, r1 and r2. Now project that area element dU (28) onto the surface of the hemisphere S along the z-axis, thereby defining another surface element dS (29).

Now, let us suppose that we transform the light, arriving to the surface element dS (29), uniformly inside the surface element dU (28). When we do this transformation over the whole surface U (26), we have transformed all light, arriving from the Lambertian source 22 to the hemisphere, onto the area U (26). At the same time, we will get the illumination we wanted; similar uniform rectangular illumination patterns over the whole area U (26). The beam over the area U (26) will have the same etendue as the Lambertian source 22.

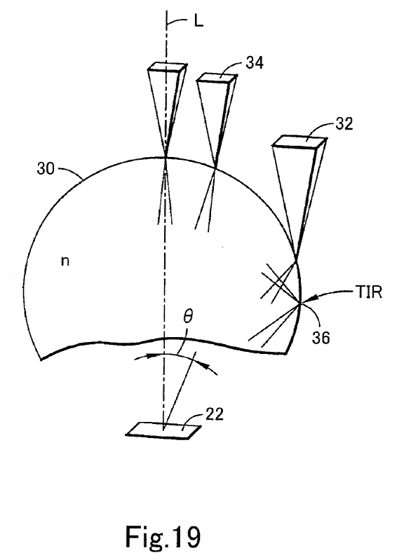

Near the axis L, i.e. when angle θ is close to the zero, the desired transformation is inherently done, i.e. no optics is needed. In other words, with small angle θ, the solution is simple: a lens surface will do a good transformation. For example, if the LED is encapsulated inside a material having a refractive index n=1.5, a lens surface whose radius of curvature is approximately R/2 and whose center of curvature is located at the optical axis L and approximately at distance R/2 from the Lambertian source 22 will form the desired light output pattern, as shown in FIG. 19 in the two projections nearest the optical axis L. The exact shape of the surface can be designed with optical design software. When only one surface is needed, the best shape is typically aspherical.

However, as can be seen from FIG. 19, as the angle θ increases, the lens surface 30 comes closer to the Lambertian source 22, and so the cone 32 of the beam becomes larger than a corresponding cone 34 of a beam emanating from a smaller angle θ nearer the optical axis L, and illumination (i.e., intensity of the illumination) is no longer uniform. Additionally, these cone shaped projections 32 resulting from the larger θ angles become distorted further away from the ideal rectangular. Finally, at large θ angles, the light becomes total internal reflected TIR 36 from the lens surface 30, for example when the angle θ approaches about 45 degrees. As noted above though, the lens performs well for small θ angles.

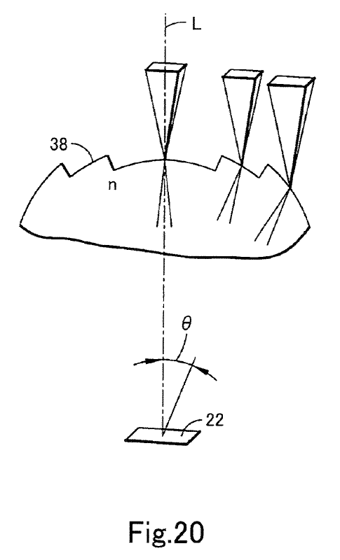

The maximum angle θ for using a lens as a good approximation can be extended for example up to about 40 degrees by using a Fresnel-lens like structure 38, as shown in FIG. 20, depending on the quality of the needed illumination. The Fresnel-lens structure 38 has the advantage that the illumination uniformity and image distortions can be improved. Drawbacks of the Fresnel-lens structure 38 are possible losses of light and increases in etendue in the surface direction discontinuities.

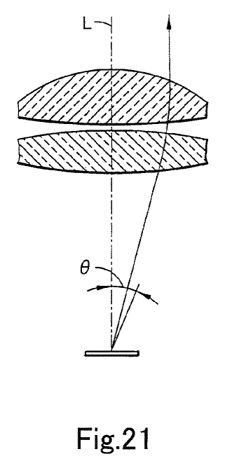

Of course several optical surfaces can be used instead of only one, for example two or more lenses as shown in FIG. 21. However, these lens solutions start to have similar problems as described above, when the angle θ increases further away from the optical axis L.

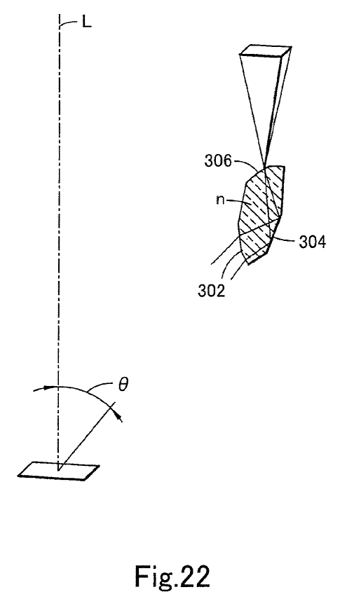

Around medium θ angles (i.e. near 45 degrees for example) where abovementioned lens or Fresnel-lens like structures 38 cannot be used, the desired transformation can be approximated for example by a mirror or a catadioptric structure for example such as shown in FIG. 22, which contains the first refractive surface 302, a mirror surface 304 and the second refractive surface 306. The mirror surface 304 can be either TIR-based or a mirror coated surface.

For larger θ angles, the transformation can be done by using one or more structures that form an “imaging channel” according to these teachings. Such imaging channels are cylindrically symmetric. A cross section of an exemplary imaging channel is shown in FIG. 6.

The imaging channel with a mirror surface forms a mirror image of the source, just like a lens or Fresnel lens system does near the optical axis. In the tangential direction, only a mirror image of the source can be formed in an imaging channel. However, the imaging channel without a mirror surface forms an image of the source which is not a mirror image in the axial cross-sectional plane including the optical axis. Therefore, the channel without a mirror surface does not form an image of the source unless the source is substantially axially symmetric. Therefore such a channel is suitable to be used for illumination purposes with substantially axially symmetric sources in particular. However, such a channel can also be used with non-axially symmetric sources, such as rectangular sources for example, if a certain amount of non-imaging is desired for smoothing the image of the source for illumination purposes for example. One embodiment of the illuminator uses both imaging channels with a mirror surface and imaging channels without a mirror surface. Such an illuminator forms both mirror images and non-mirror images of the source in the radial direction, and those images are laid on top of each other at the image plane (beyond the exit pupil). Such optical lenses can be used to create more uniform illumination from a source, than what would be obtained with direct imaging of the source.

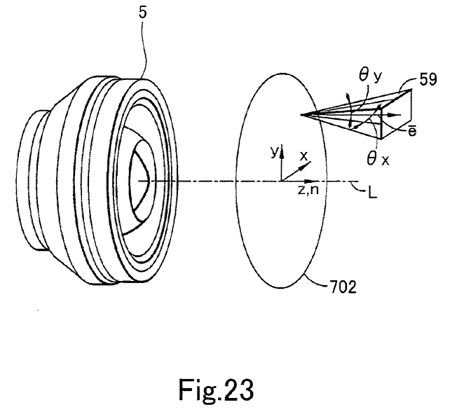

As shown in FIG. 23, light from the LED source 3 is converted to an average direction approximately parallel to the optical axis L. Additionally, the light from the LED source 3 is converted to substantially rectilinear uniform illumination as seen by the schematic cone 59 on the illuminator output plane 702. The rectilinear uniform angular distribution pattern is defined by the angles θx and θy, which mean the half opening angles of the rectilinear cone 59 in the x and y directions. If the LED source 3 would not be rectangular but for example a circle or triangle instead, the illumination cones 59 would have a corresponding shape.

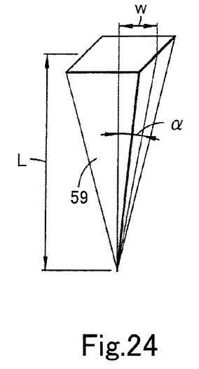

The optical lens 5 has spatially a circular output light emitting area, which ensures a good pupil matching with the projection lens 8. Now, let the diameter of the illuminator output emitted from the optical lens 5 be D. A rectangular light “cone” 59 is defined by angle α as shown in FIG. 24. The optical lens 5 design allows adjustment of the output diameter D and the cone 59 angle α. For an LED source 3 of a certain size, the diameter D is inverse proportional to each other according to the etendue law (see U.S. Pat. No. 7,059,728).

If the optical channels and the overall optical lens 5 are designed for telecentric output, the cones 59 radiate perpendicular to the output plane 702 and, in this case, an extra relay lens is needed. The channels and the optical lens 5 can also be designed for non-telecentric illumination so that no extra lens is needed. The relay lens function can be incorporated to the uppermost surfaces of the channels.

The exit face T107 can be modified so that the beam is tilted towards the optical axis L, or further away from the optical axis L as desired. In some applications, it might be desirable to vary this tilt a bit as a function of radius. This can also be implemented by modifying the lens element design. For example, it is possible to decrease the angle α gradually as one moves from the center of the illuminator output plane 702 towards the edges. That may be beneficial in very low F-number/F-stop systems.

If the light source is not uniform and we would like to achieve a uniform image, we can apply a smoothing effect which makes the illumination more uniform by designing a different angular “magnification” to different zones of the channel output. Also we can modify the beam shape differently in different zones of the channel output and that can also be used to smooth the illumination. These approaches implement the smoothing at the cost of increased etendue or increased losses, and departing from the accurate imaging function.

One way to smooth the illumination is to incorporate a difference in magnification in radial and tangential directions in certain or all zones of the optical lens. That smoothes the image tangentially (i.e. cylindrically) by a desired amount and in the desired zones only. This also is at a cost of increased etendue or losses. The tangential magnification can be adjusted by adjusting the distance of the channel entrance and exit pupils from the optical axis L, i.e. departing from the rule of equal radius purposefully. The radial magnification can be adjusted by adjusting the magnification of the 2D-optical system of the axial cross-section plane of the channel.

The channels have the capability to create rectangular illumination with uniform intensity distribution and sharp edges. Sometimes that result is not the most desired illumination form; sometimes it is desired to have brighter illumination at the center of the rectangular illumination and dimmer illumination at the corners. But for some applications, the desired output can be opposite; a dimmer center and brighter corners. Any of these illumination results can be implemented by using the abovementioned smoothing and adjusting approaches. Still another way to smooth the illumination is to use both mirroring and non-mirroring channels in the same optical lens, as was also described above.

It is possible to vary the size of the rectangular radiation pattern across the circular output of the optical lens. For example, in miniature projection applications, one might desire to have the size of the radiation pattern decrease slightly when going from the center of the circle towards the edges. This option can be implemented by having the radius of the circular area a bit larger than the radius R of the hemisphere S, and modifying the transformation accordingly.

The shape of the illumination emanated from the optical lens 5 matches the xy-shape of the LED source 3. This means that the rectangularly shaped illumination is formed by using the rectangular shape of the LED source 3 (i.e. the LED source 3 is practically imaged so that the entrance pupil of the optical lens 5 covers the whole hemisphere). Because the optical lens 5 images the shape of the LED source 3 to the illuminated plane, the channels and lens elements can be designed to form illumination of any shape defined by the LED source 3 (for example, circular, elliptical, triangular, rectangular, square etc.)

Of course the optical lens 5 is not mandatory to collect all the light from the LED source 3. For example, sometimes it is advantageous to collect only part of the source light, i.e. the brightest area from the LED source 3. Or sometimes the optical lens 5 is not advantageous to collect the whole hemisphere. For example, in the case that the rest of the optical engine cannot handle such a large etendue, one can collect only the desired part of the hemisphere by using the same concept. For example, one might want to collect light at angles only between 0 and 70 degrees from the optical axis L, or one may elect to collect light from only angles between 0 and 80 degrees instead of the full hemisphere 0 to 90 degrees. For example, if one desires to collect the light at angles only between 0 and 50 degrees from the optical axis L, it may be implemented by a Fresnel lens near the axis L and one imaging channel with mirror surrounding the Fresnel lens. Or sometimes one might want to collect light at angles from 45 to 90 degrees only, in the case of which the component may be implemented without the central lens or Fresnel part by three imaging channels with mirror for example.

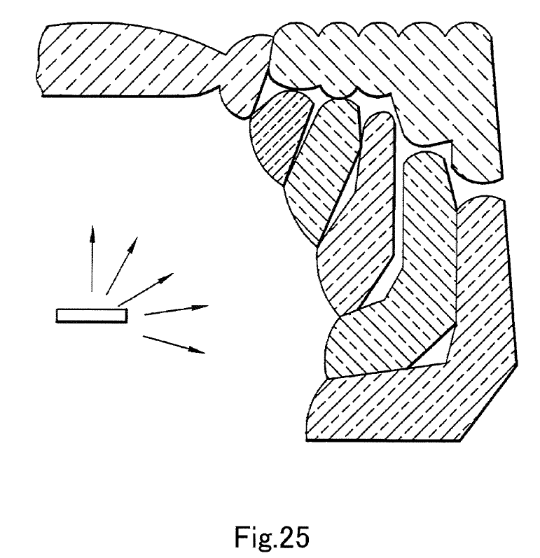

It is also possible to collect the light emitted to larger solid angles than a hemisphere. By using the imaging channel structures defined herein, it is possible to collect light from 0 to nearly 135 degrees from the optical axis L also. For example, it is possible to collect light from 0 to nearly 135 degrees from the optical axis L by using the structure shown in FIG. 25. However, the accuracy of the image starts to deform as the collection angles increase beyond 90 degrees, because the tangential magnification starts to decrease from what would be required for good imaging properties. However, no other approach is seen to image at angles 40-140 degrees from the optical axis L, and particularly at 45-135 degrees from it. The imaging beyond 90 degrees can be implemented when the LED source 3 is encapsulated with a material having an index of refraction greater than one, near 1.5 for example.

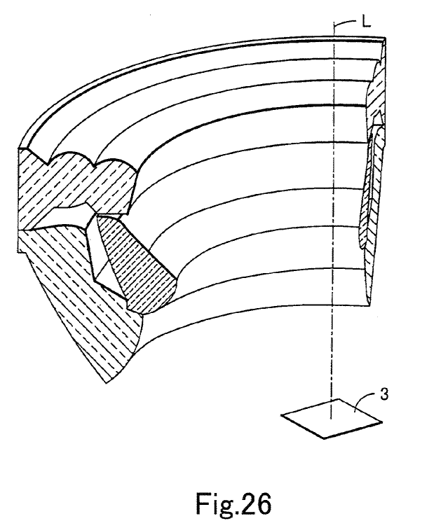

The imaging channels are not limited to surfaces which are cylindrically symmetric over a full 360 degrees. An example is shown in FIG. 26, which is fully working imaging or illumination device being cylindrically symmetric and covering a 90 degree sector around the axis L of rotation. Still another embodiment of the imaging channels is composed of two or more non-cylindrically symmetric lens elements, which together form a substantially cylindrically symmetric imaging channel. For example, the cross-sections of the imaging channel perpendicular to the axis L, instead of being smooth circles, could be a piecewise linear approximation of a circle, in such a way constructed as imaging channels.

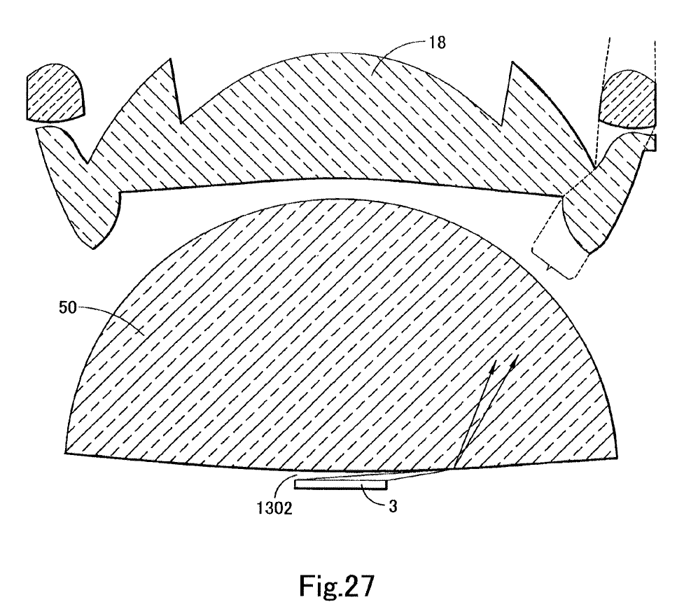

When the LED source 3 is surrounded by air, it is possible to reduce the amount of needed channels by adding an approximately hemispherical lens (which typically is an aspherical lens, i.e. dome) close to the LED source 3 but so that there remains a small air gap 1302 between the LED source 3 and the dome lens 50, as shown in FIG. 27. In this case, it is possible to image light emitted to almost the whole hemisphere with the fourth lens element 18 together with one or two channels, which simplifies the overall system.

An embodiment of the imaging channels can be described as follows: Every axial cross-section of a channel including the axis L contains a 2D-optical system. The optical axis of this 2D-optical system is the optical axis of the channel in axial cross-section plane. This is different from the optical axis L. The optical axis of the channel in an axial cross-section plane does not intersect with the optical axis L between the radial entrance and the exit pupils of the channel. A radial entrance pupil of the channel is the entrance pupil of the 2D-optical system of the channel, which is typically approximately at the entrance surface of the channel. A radial exit pupil of the channel is the exit pupil of the 2D-optical system of the channel, which is typically as approximately at the exit surface of the channel.

An axial cross-section of a channel has three functional parts which can be integrated together. These three functions are designed into the channel, and are, in the below order from object to image:
(1) Imaging the object to an intermediate image (in axial cross-section plane)
(2) Imaging the radial entrance pupil of the channel into the exit pupil of the channel (in axial cross-section plane).
(3) Imaging the intermediate image to the image (in axial cross-section plane).
   All of these three functions may be embodied as toroidal lens elements. Typically functions (1) and (2) are embodied by lens elements whose 2D-cross-section at any axial cross-section plane has positive optical power. Function (3) can be embodied as a lens element with either positive, negative or even zero optical power (typically it has positive power). Each function can be embodied as several optical surfaces, refractive, reflective or diffractive. Surfaces can be integrated together, too. Typically the best results are achieved by using at least one aspheric surface (i.e. an optical surface which does not have cross-section which is an arc of circle) per channel.

An imaging channel is cylindrically symmetric and its purpose is to substantially form an image from an object. Of course the real parts which belong to an imaging channel apparatus can physically encompass other parts which are not cylindrically symmetric. Those portions of the imaging channel, which implement the imaging function are substantially cylindrically symmetric and the other parts which do not implement the imaging function need not be cylindrically symmetric.

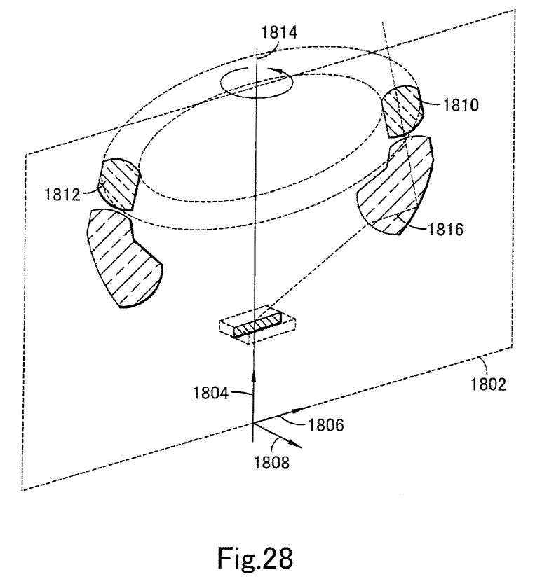

FIG. 28 shows an axial cross-section plane 1802 and the axial 1804, radial 1806 and tangential 1808 direction vectors related to the axial cross-section plane 1802. The operation of an imaging channel can be described by using this coordinate definition.

In any axial cross-section plane crossing an imaging channel, the imaging channel defines a two dimensional ray guiding system 1810. The imaging channel may also define two systems 1810 and 1812 which are mirror systems in respect to the axis 1814 as shown in FIG. 28. That may happen when the imaging channel is cylindrically symmetric about the axis 1814 over more than 180 degrees. In the following description, we refer to only one of these two dimensional ray guiding systems, i.e. for example to the right-hand-side system 1810 of FIG. 28. Note that the two dimensional ray guiding system has an optical axis 1816, which is not the same than the axis 1814 of revolution of the imaging channel, but substantially different. Therefore the optical axis of the two dimensional optical systems are different for every individual axial cross-section plane.

Meridional rays mean the rays originating from the object along the axial cross-section plane. Typical optical systems have an entrance and an exit pupil. Similarly, each two dimensional ray guiding system has an entrance pupil and an exit pupil on the same axial cross-section plane. The entrance pupil can be a real or a virtual aperture that is defined such that the meridional rays going from the object's cross-section towards the aperture are guided through the two dimensional optical system. The exit pupil can be defined with similar analogy to the ray optics.

A specific feature of the imaging channel is that the meridional rays from the object are imaged by the two dimensional ray guiding system of a axial cross-section plane to an intermediate image on the same axial cross-section plane, and the intermediate image is further imaged to the image. In addition to that, the imaging channel characterized in that the intermediate image of the object does not cross the axis 1814 of revolution of the imaging channel, from which it follows that the intermediate images of the individual axial cross-section planes do not cross each other on the axis 1814 of revolution. The individual axial cross-section planes intersect only on the axis of revolution and thus the intermediate images of the individual axial cross-section planes cannot cross each other anywhere.

This differs from the teachings of the existing collimation, beam shaping, and imaging devices, such as TIR-collimators or high-NA objectives for example. Those devices do not either form the intermediate image and image as described above, or if they form an intermediate image, the intermediate images of the individual axial cross-section planes cross each other at some location. That can happen for example when the optical axes of the two dimensional ray guiding systems of individual axial cross-section planes substantially coincide with the axis of revolution of the device.

According to the abovementioned imaging arrangement, the imaging channel forms an image of the object in every individual axial cross-section plane. How about the rays, which are not propagating in any axial cross-section plane, i.e. so called skew rays? Accurate tracing of skew rays through a cylindrically symmetric ray guiding systems is taught for example in Chapter 3 of the book “An Introduction To Ray Tracing” by A. S. Glassner, Morgan Kaufmann Publishers, 9th edition, 2002. When a path of a skew ray is presented in a general (r,z)-coordinate system (i.e. horizontal axis denoted by r is the distance from the axis of rotation, and vertical axis is the z-coordinate), the paths of the ray follow sections of second degree curves instead of typical sections of straight lines. An important finding of the invention is that when an imaging channel is arranged so that the distances of the object points from the center of the entrance pupil of the two dimensional ray guiding system of an axial cross-section plane, are substantially larger than the distances of the object points from the same axial cross-section plane, the skew rays can be substantially treated as meridional rays when calculating the radial component of the skew ray through the imaging channel. It follows that if we project a skew ray incoming to the entrance pupil of an individual axial cross-section plane, along the tangential direction to the axial cross-section plane, and so obtain a meridional ray, we can trace the obtained meridional ray through the two dimensional ray guiding system, and so obtain the radial component of that meridional ray at the exit pupil. The magnitude of the radial component of that meridional ray at the exit pupil is now substantially the same as the magnitude of the radial component of the skew ray at its exit pupil. The accuracy of how well this approximation is true depends on the ratio of the abovementioned dimensions. For example, when the distance of the object from the entrance pupil is approximately three times larger than the maximum width of the object, a good enough approximation is obtained for illumination quality images. So, the radial component of any ray on any individual exit pupil, both meridional and skew rays, is known and defined by the radial shape of the imaging channel.

From the arrangement that in each individual two-dimensional ray guiding system the imaging channel forms an intermediate image of the object and then further images the intermediate image to the image, it follows further that the imaging channel substantially images the entrance pupil to the exit pupil in each individual axial cross-section plane. The (full) entrance pupil of an imaging channel consist of all the points, which belong to some entrance pupil of some two-dimensional ray guiding system. Similarly the (full) exit pupil of an imaging channel consist of all the points, which belong to some exit pupil of some two-dimensional ray guiding system. Now, all points on the (full) entrance pupil are substantially mapped to a certain point on the (full) exit pupil. In other words, the entrance pupil is substantially imaged to the exit pupil.

In order to complete the imaging function for the skew rays, the imaging needs to be done also in tangential directions of the imaging channels. That is implemented in an innovative way by using the skew invariance property of the rotational symmetric ray guiding systems (look for example book “Nonimaging Optics” by Roland Winston, Elsevier Academic Press 2005, Chapter 10).

The skew invariant (or skewness) of the ray is defined by

S≡\vec{r}·(\vec{K}×\vec{a})

Wherein

\vec{a}

is an unit vector oriented along the axis of rotational symmetry,

\vec{K}

is a vector of magnitude equal to the constant depending on the material where the ray is propagating (i.e. the index of refraction in optical radiation) and oriented along the ray's propagation direction, and

\vec{r}

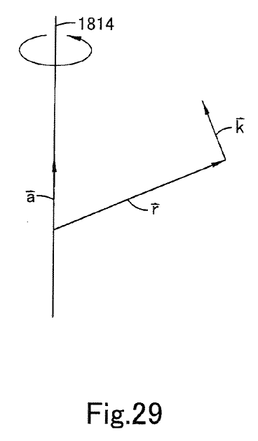

is any vector connecting the axis of rotation to the ray, see FIG. 29.
The skew invariance states that the skew invariant of a ray is conserved in any rotational symmetric ray guiding system.

Let us look any ray at the exit pupil of the imaging channel. As shown in FIG. 29, let the ray components in the axial, radial and tangential directions to be

\vec{Ka}, \vec{Kr}, \vec{Kt}

Let the unit vector along the axial direction to be

\vec{a}

Let the vector linking the optical axis with the ray be

\vec{r}

Now the skew invariant of the ray is

$$\begin{matrix}S ≡ \vec{r} \cdot ( ( \vec{Kt} + \vec{Ka} + \vec{Kr} ) \times \vec{a} ) \\ = \vec{r} \cdot ( \vec{Kt} \times \vec{a} + \vec{Kr} \times \vec{a} ) \\ = \vec{r} \cdot \vec{Kt} \times \vec{a} \\ = rKt\end{matrix}$$

where r is the distance of the ray from the axis of rotation at the exit pupil, and Kt is the magnitude of the tangential component of the ray at the exit pupil.
The simplification is possible because

\vec{Ka}×\vec{a}=0

and

\vec{K}×\vec{a} ⊥ \vec{r}

The same calculations can also be made for the rays at the entrance aperture.
There it follows that the tangential component of a ray at the exit pupil is related to the tangential component of the corresponding ray at the entrance pupil by the relation

$$Kt = \frac{{r}^{′}}{r} {K}^{′} t$$

where K′t and r′ relate to the ray at the entrance pupil of the imaging channel.
So, by adjusting the mapping from the entrance pupil to the exit pupil, the tangential components of the skew rays can be adjusted. Specifically, by that way, the tangential imaging can be matched to the radial imaging, and therefore the imaging function of the imaging channel is completed for skew rays, too.

A specific feature of an embodiment of the invention is that the entrance pupil is mapped to the exit pupil in such a way that the corresponding points at the entrance pupil and at the exit pupil have substantially the same distance to the axis of rotation. By using such embodiments of the imaging channel, it is possible to image rays emanating from an object to a whole hemisphere (or more) about the object.

The imaging channel can be designed to have different imaging properties in the radial and tangential directions. The degree of imaging can be adjusted separately in the radial and tangential directions. The imaging channel is able to substantially image an object from directions forming an angle from 0 to 135 degrees to the axis of rotation. That is because the imaging channel allows much more degree of freedom for arrangements of the ray guiding components than conventional imaging teachings.

It is notable that implementation of an imaging channel needs guiding of the ray in three distinct locations at minimum, which of course can be implemented by one component too if it extends to these three distinct locations.

It is also notable that the teaching of the invention is valid as well if an imaging channel, instead of forming one intermediate image in an axial cross-section plane, forms two or more successive intermediate images which are conjugates of each other and which are conjugates of the object and the image. That allows still more degrees of freedom how the path of the beam can be arranged. By that way, it is possible to have relatively long imaging channels which still have high NA per channel.

An embodiment of the imaging channel of the invention is a device comprising at least three ray guiding components which are substantially cylindrically symmetrical about an axis. Such ray guiding component can be any substantially cylindrically symmetric structure, which guides the rays by changing the direction of at least some of the rays. Such ray guiding component changes only those components of the direction vector of a ray, which components are perpendicular or parallel to the axis of revolution of the component (i.e. the components which are on the axial cross-section plane of the component), and does not substantially change the remaining component of the ray direction vector (i.e. the tangential direction vector in respect to the axis of revolution of the component).

In an embodiment of the imaging channel, the entrance pupil is defined to be part of the physically possible entrance pupil. The object can be defined to be any source of rays, or a portion of it, or an image or virtual image of it, as described above.

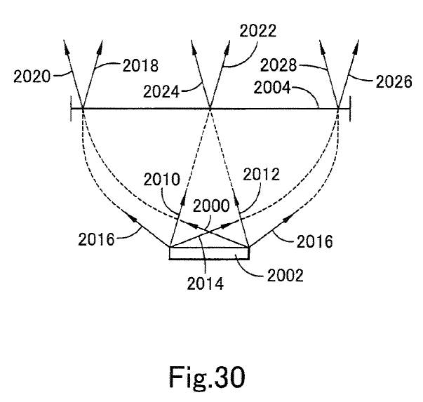

FIG. 30 shows a Lambertian source 2002 together with an illumination pupil 2004 above it. The source 2002 emits light into a large opening angle, for example into the whole hemisphere. Every point at the illumination pupil has angular distribution of light which creates an image of the source towards infinity. The image could be made to some other distance than infinity too, but here telecentric output is chosen just for an exemplary case. The width of the illumination pupil and the angular opening angle are related by the etendue law. This is the goal of the high-NA imaging, and also a goal of an ideal illumination system.

FIG. 30 further shows rays (2000, 2010, 2012, 2014, 2016) originating from the source 2002 and corresponding rays (2018, 2020, 2022, 2024, 2026, 2028) at the illumination pupil 2004. The problem is now how to design and create such an optical system that all the rays are guided to the corresponding rays at the illumination pupil at the same time (exemplary ray paths shown as dashed lines), and in 3D, whereas this figure shows only 2D-case. Many conventional solutions, for example high-NA lens systems try to solve this problem by handling all the rays by the same lens components. That causes several restrictions to the geometry what can be used and therefore conventional systems have not been able to implement well the abovementioned system without severe drawbacks, and especially when the source is inside material with higher index of refraction than unity. It is easy to understand that it is conventionally easy to get the central area working well but if we want to get the central area working and at the same time get the side-emitted light handled properly too, that is much more difficult.

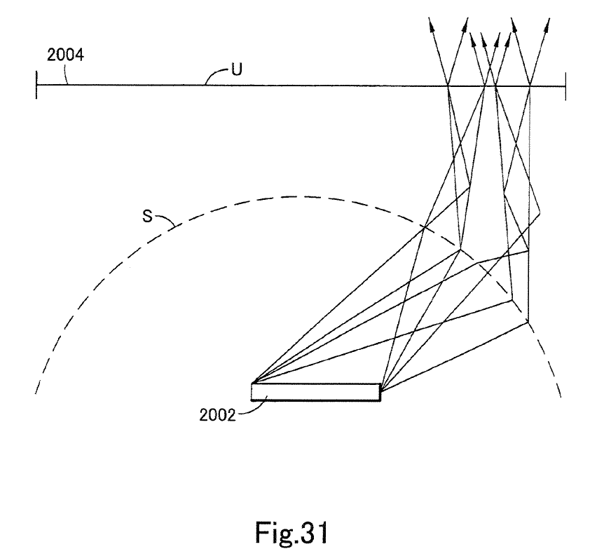

The imaging channels presented above provide real solution for that problem. There is no need to guide all the rays with the same optical surfaces. The continuous flow of rays is divided to several cylindrically symmetric “channels” at some surface S (approximately hemisphere which was described above, it can also differ from the hemisphere depending on the optimization of the design). Each channel can now be designed separately so that the rays are transferred to the needed location and directions and the optical system can now be different for different vertical angles (theta) above the source. That gives much more degrees of freedom to the design and allows the use of above described channels of the invention, which do the desired transformation. The beams from the channels are then combined on the surface U to a one solid beam of light. In order to preserve the etendue of the beam, the entrance pupils and the exit pupils of the 2D-optical system of every channel axial cross-section plane need to form continuous surfaces. In addition to that the directions of the output beams from the channels need to be adjusted so that the angular distribution is also smooth over the whole output plane of the illuminator. FIG. 31 shows schematically exemplary ray paths implemented by the channels.

The technical idea which can be grasped from the above-mentioned explanation is described below.
(1) A device comprising:

a first toroidal ray guide defining an axis of revolution and having a toroidal entrance pupil adapted to image radiation incident on the entrance pupil at an angle to the axis of revolution between 40 and 140 degrees,

the first toroidal ray guide having a first imaging surface opposite the entrance pupil and a second ray guide also defining the axis of revolution and having a second imaging surface adjacent to the first imaging surface.
(2) The device in which the angle is between 45 and 135 degrees.
(3) The device in which a surface of the first toroidal ray guide outboard from the axis of revolution comprises a reflective surface.
(4) The deice in which the toroidal entrance pupil comprises a first entrance pupil and in which the first imaging surface is adjacent to a first portion of the second imaging surface,

the device further comprising:

a third toroidal ray guide also defining the axis of revolution and having a toroidal second entrance pupil adapted to image radiation incident on the entrance pupil at an angle to the axis of revolution between 40 and 140 degrees,

the third toroidal ray guide having a third imaging surface opposite the second entrance pupil, and wherein the third toroidal ray guide is disposed inboard the first toroidal ray guide.
(5) The device further comprising a light source disposed along the axis of revolution such that light emanating directly from the source is incident on the entrance pupil at an angle to the axis of revolution between 40 and 140 degrees, and the axis of revolution comprises a system optical axis of the device.
(6) The device in which:

the first entrance pupil is adapted to guide substantially all light incident upon it from the light source through the first toroidal ray guide and to the first imaging surface; and

the second entrance pupil is adapted to guide substantially all light incident upon it from the light source through the third toroidal ray guide and to the third imaging surface.
(7) The device in which the first toroidal ray guide and the second toroidal ray guide are made of a same optical material having a refractive index between about 1.3 and about 1.7.
(8) The device in which the same optical material is selected from the group consisting of cyclic olefin copolymer, polymethyl methacrylate, polycarbonate, and polystyrene.
(9) The device further comprising a light source disposed along the axis of revolution such that light emanating directly from the source is incident on the entrance pupil at an angle to the axis of revolution between 40 and 140 degrees, wherein the axis of revolution comprises a system optical axis of the device.
(10) The device in which the light source is disposed between a reflective surface and a substantially hemispherical dome that faces the entrance pupil.
(11) The device in which at least one of the dome and the entrance pupil comprises a fourth imaging surface.
(12) The device in which the fourth imaging surface and the first imaging surface are adapted to form an intermediate image from the light source at a plane perpendicular to the system optical axis and adjacent to the first imaging surface.
(13) The device in which the second toroidal ray guide comprises an exit pupil disposed opposite the second imaging surface and the exit pupil comprises a fifth imaging surface.
(14) The device in which the first toroidal ray guide is adapted so as to redirect substantially all light incident at the entrance pupil from the light source to the first imaging surface.
(15) The device in which the first and second toroidal ray guides are adapted so as to convert substantially uniform circular illumination from the light source to substantially uniform rectilinear illumination at the exit pupil.
(16) The device further comprising a Fresnel lens centered on the axis of revolution.
(17) The device in which outboard portions of the Fresnel lens lie adjacent to the second imaging surface.
(18) The device in which the second ray guide is a toroidal ray guide.
(19) A device comprising:

at least one ray guide substantially cylindrically symmetrical about an axis;

the at least one ray guide being arranged to substantially image at least a portion of the rays, which emanate from a non-point object towards an entrance pupil of the at least one ray guide, to an image; and

in each individual cross-sectional plane which includes the axis and a portion of the entrance pupil, the at least one ray guide being arranged to image an individual subset of the rays which emanate from the non-point object along the individual cross-sectional plane towards a portion of the entrance pupil which is on the individual cross-sectional plane and on one side of the axis to an intermediate image on the individual cross-sectional plane, and to further substantially image the at least a portion of the rays from the intermediate image to an cross-sectional image on the cross-sectional plane, which cross-sectional image substantially coincides with a cross-section of the image at the individual cross-sectional plane, such that no two the intermediate images of two different individual cross-sectional planes cross each other.
(20) The device in which the at least one ray guide is arranged such that no ray of the individual subset of rays crosses the axis between the cross-section of the entrance pupil and the cross-section of the exit pupil of the at least one ray guiding component which is on the same half of the individual cross-sectional plane in respect to the axis than the cross-section of the entrance pupil.
(21) The device in which the at least one ray guide is arranged to substantially image the entrance pupil to the exit pupil on each of the cross-sectional half planes bounded by the axis.
(22) The device in which the at least one ray guide is arranged to substantially image substantially all rays, which emanate from the non-point object towards the entrance pupil of the said at least one ray guide, to the image.
(23) The device in which the at least one ray guide is arranged such that conjugate points in the entrance pupil and in the exit pupil are spaced from the axis by a substantially equal distance.
(24) The device in which the at least one ray guide is arranged such that any point which is substantially imaged from the non-point object to the image forms a spot on the image such that its root mean square-spot size is substantially smaller than a mean diameter of the image.
(25) The device in which the root mean square-spot size is smaller than one fourth of the mean diameter of the image.
(26) The device in which the at least one ray guide is arranged such that an average distance from the non-point object to the entrance pupil is substantially larger than a mean distance from the non-point object to the axis.
(27) The device in which the average distance from the non-point object to the entrance pupil is at least three times larger than the mean distance from the non-point object to the axis.
(28) The device in which the rays are rays of electromagnetic radiation between ultraviolet and infrared wavelengths.
(29) The device in which the rays of electromagnetic radiation are rays emitted from a light-emitting diode.
(30) The device which is an illumination component of an image forming system.
(31) The device in which the at least one ray guide is arranged such that at least one line between the entrance pupil and a point on the axis, which point is nearest to an average point of the non-point object, forms an angle greater than 35 degrees with the axis.
(32) The device in which the at least one ray guide is arranged such that every line between the entrance pupil and a point on the axis, which point is nearest to an average point of the non-point object, forms an angle greater than 30 degrees with the axis.
(33) The device in which the at least one ray guide is arranged to change the propagation direction of the at least portion of the rays successively at least in three distinct locations per ray.
(34) The device in which the at least one ray guide is arranged to change the propagation direction of the at least portion of the rays successively at no more than five distinct locations per ray.
(35) The device in which the at least one ray guide is arranged such that the entrance pupil covers a solid angle of at least 0.1 steradians about a point on the axis which is nearest to an average point of the non-point object.
(36) A device comprising:

at least one ray guiding component substantially cylindrically symmetrical about an axis of revolution;

the at least one ray guiding component being arranged to substantially image at least a portion of the rays, which emanate from a non-point object towards an entrance pupil of the at least one ray guiding component, to an image;

the at least one ray guiding component being arranged to substantially image the entrance pupil into an exit pupil of the at least one ray guiding component, such that each point on the entrance pupil is substantially imaged to a projection of the point substantially along the direction of the axis of revolution on the exit pupil;

the at least one ray guiding component being arranged to have substantially all points of the entrance pupil at approximately a same distance from the object; and

the at least one ray guiding component being arranged so that no path of any meridional ray imaged from the entrance pupil into the exit pupil crosses the axis of revolution between the entrance pupil and the exit pupil.
(37) The device in which the at least one ray guiding component is arranged to have length along the axis smaller than a diameter of the exit pupil.
(38) The device in which the at least one ray guiding component is arranged such that the entrance pupil covers a solid angle of at least 3 steradians about a point on the axis, which point is nearest to an average point of the non-point object.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A projection display device for enlarging and projecting image on a screen comprising:
a three-color LED source which comprises a red LED, a green LED and a blue LED;
a light pipe for making uniform illumination distribution of light emitted from the three-color LED source;
an optical lens for making the light from the light pipe into parallel light; and
a light modulation element which includes a light modulation part for modulating the light from the optical lens;
wherein the optical lens comprises;
a first toroidal lens element which is provided with a first entrance face which is formed in a ring shape and on which the light whose angle with respect to an optical axis is a predetermined angle is incident to image the light, and a first exit face which is formed in a ring shape and which emits the light incident from the first entrance face; and
a second lens element which is provided with a second entrance face which is formed in a ring shape and which is adjacently disposed to the first exit face in an optical axis direction.

2. The projection display device according to claim 1, wherein the angle with respect to the optical axis of the light which is incident on the first entrance face is between 40° (degrees) and 90° (degrees).

3. The projection display device according to claim 1, wherein the first lens element is provided with a reflection face which totally reflects the light incident on the first entrance face toward the first exit face.

4. The projection display device according to claim 2, wherein the first lens element is provided with a reflection face which totally reflects the light incident on the first entrance face toward the first exit face.

5. The projection display device according to claim 1, wherein
the optical lens includes a third lens element which is provided with a third entrance face which is formed in a ring shape and on which the light whose angle with respect to the optical axis is between 40° (degrees) and 90° (degrees) is incident to image the light, and a third exit face which is formed in a ring shape and which emits the light incident from the third entrance face, and
the second lens element is provided with a fourth entrance face which is formed in a ring shape and which is adjacent to the third exit face in the optical axis direction, and
the third lens element is disposed on an inner side in a radial direction of the first lens element.

6. The projection display device according to claim 2, wherein
the optical lens includes a third lens element which is provided with a third entrance face which is formed in a ring shape and on which the light whose angle with respect to the optical axis is between 40° (degrees) and 90° (degrees) is incident to image the light, and a third exit face which is formed in a ring shape and which emits the light incident from the third entrance face, and
the second lens element is provided with a fourth entrance face which is formed in a ring shape and which is adjacent to the third exit face in the optical axis direction, and
the third lens element is disposed on an inner side in a radial direction of the first lens element.

7. The projection display device according to claim 3, wherein
the optical lens includes a third lens element which is provided with a third entrance face which is formed in a ring shape and on which the light whose angle with respect to the optical axis is between 40° (degrees) and 90° (degrees) is incident to image the light, and a third exit face which is formed in a ring shape and which emits the light incident from the third entrance face, and
the second lens element is provided with a fourth entrance face which is formed in a ring shape and which is adjacent to the third exit face in the optical axis direction, and
the third lens element is disposed on an inner side in a radial direction of the first lens element.

8. The projection display device according to claim 4, wherein
the optical lens includes a third lens element which is provided with a third entrance face which is formed in a ring shape and on which the light whose angle with respect to the optical axis is between 40° (degrees) and 90° (degrees) is incident to image the light, and a third exit face which is formed in a ring shape and which emits the light incident from the third entrance face, and
the second lens element is provided with a fourth entrance face which is formed in a ring shape and which is adjacent to the third exit face in the optical axis direction, and
the third lens element is disposed on an inner side in a radial direction of the first lens element.

9. The projection display device according to claim 1, wherein the red LED, the green LED and the blue LED are mounted on a common circuit board.

10. The projection display device according to claim 1, wherein an emitting port for light of the light pipe is provided with a similar shape to shape of the light modulation part.

11. The projection display device according to claim 1, wherein the three-color LED source is disposed in an inside of the light pipe.
